(19) United States
(12) Patent Application Publication
(10) Pub. No.: US 2013/0108742 A1
(43) Pub. Date: May 2, 2013

(54) Dual Hot Dog Meat Product

(71) Applicant: Charles Garitee, Pelham, NY (US)

(72) Inventor: Charles Garitee, Pelham, NY (US)

(21) Appl. No.: 13/281,578

(22) Filed: Oct. 26, 2011

(51) Int. Cl. A23L 1/31

(52) U.S. Cl. 426/94

(57) ABSTRACT

A meat product used in conjunction with a bun for the consumption of elongated cylindrical meat products comprising: a dual elongated cylindrical meat product, where the meat product is served within the bun. The bun includes a first half; a first well within the interior of the first half, where the first well provides a means for the placement of a first portion of the meat product; a second half, where the second half adjoins the first half along one side the second half; and a second well within the interior of the second half, where the second well provides a means for the placement of a second portion of the meat product.

### BACKGROUND OF THE INVENTION

1. Field of Invention

The present invention relates to a dual hot dog meat product that may be consumed out of a bun that is able to contain the meat product for consumption by the consumer.

2. Description of Related Art

A hot dog is a meat product typically consumed in a soft bread bun that is used to contain a hot dog. The bun allows the user to grasp the hot dog without having grease and/or condiments spill on the consumer's hands. The typical hot dog is cylindrical in shape and fits within a slit opening in the bun. The hot dog is a sausage type of meat product that may be made of beef, pork, chicken or turkey. Further the consumer may easily handle a hot dog within the bun for consumption without issues involving the greasiness or heat that may be associated with the hot dog. The hot dog is usually adorned with condiments during consumption such as ketchup, relish, mustard, onions or pickles. Although commonly used with a hot dog the hot dog bun is also used with other sausage-type of meats such as frankfurters, hot links or italian sausage.

As is commonly known in the prior art the hot dog bun itself is utilized with a single hot dog. However it would be advantageous to provide consumers with an alternative bun that can contain a dual hot dog meat product for consumption within a single hot dog bun.

### SUMMARY OF THE INVENTION

The present invention relates to a meat product used in conjunction with a bun for the consumption of elongated cylindrical meat products comprising: a dual elongated cylindrical meat product, where the meat product is served within the bun. The bun includes a first half; a first well within the interior of the first half, where the first well provides a means for the placement of a first portion of the meat product; a second half, where the second half adjoins the first half along one side the second half; and a second well within the interior of the second half, where the second well provides a means for the placement of a second portion of the meat product. The bun further includes an open position for the insertion of the meat product into each well of the bun, and a closed position for consumption of the meat product within the wells. The bun further includes a seam that provides a means for adjoining the first half with the second half and the bun completely encloses the meat product when the bun is in the closed position. In the preferred embodiment, the meat product is a hot dog.

### BRIEF DESCRIPTION OF DRAWINGS

FIG. 1 depicts a side view of a hot dog bun in accordance with the present invention.

FIG. 2 depicts a cross-sectional view of the internal opening for containing a dual hot dog meat product according to the present invention.

FIG. 3 depicts the hot dog bun according to the present invention in an open position to accommodate the dual meat product.

### DETAILED DESCRIPTION

The present invention relates to a dual meat hot dog product that provides an enlarged or a dual-sized hot dog for consumption by consumer. The meat product increases the amount of meat available in a single hot dog within a single bun. The meat product might be of similar length to a conventional hot dog but includes additional cylindrical width of meat product available for consumption. A unique hot dog bun encloses the dual meat hot dog for consumption by the consumer. The bun may be closed by the consumer to consume the dual meat hot dog within a single bun. Each well of the prospective hot dog bun is deep enough to accommodate the dual meat hot dog with some condiments. When the bun is closed for consumption each half of the bun may abut or seal and therefore enclose the dual meat hot dog fully within the single hot dog bun. Although the present invention will be described for use with a hot dog any other comparably meat product may be consumed with the bun.

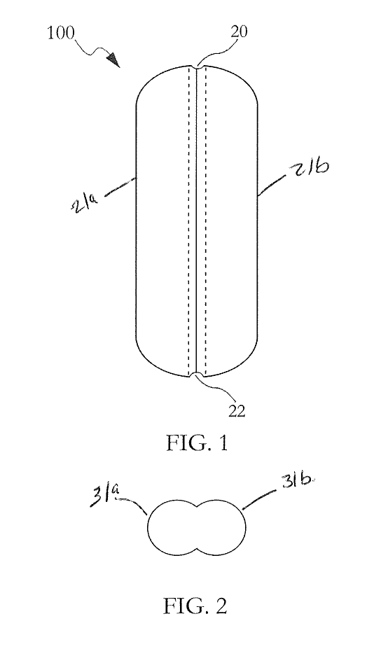

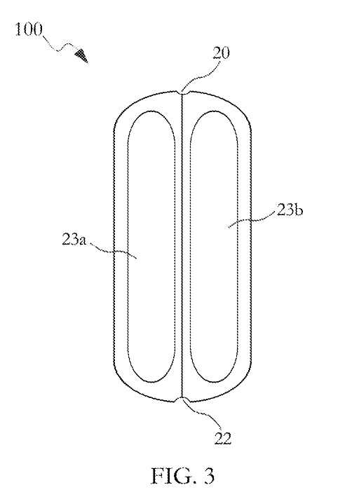

FIG. 1 depicts a side view of a hot dog bun as used in conjunction with the dual meat product according to the present invention. The hot dog bun 100 includes two sides, a first side 21a and a second side 21b. The bun is designed to contain the dual hot dog product for consumption by the consumer. Each side of the hot dog bun includes a well for insertion of a portion of the dual hot dog meat product. The wells are depicted in FIG. 3, where the hot dog bun 100 is shown in an open position. Once placed within the bun, the dual meat product is wrapped within a first well 23a and a second well 23b. The bun is of a sufficient size to contain the dual meat product and for the application of condiments as desired by the user.

FIG. 2 depicts cross-section of the dual hot dog meat product according to the present invention. As shown the dual hot dog meat product may be placed within wells 23a and 23b for consumption. The bun may vary in size to accommodate different sized hot dogs and also once closed the hot dog bun completely conceals the hot dogs for consumption.

The well design of the hot dog bun according to the present invention allows for the insertion of dual hot dog meat product in a single hot dog bun for consumption by the consumer. Further the opening as provided within the bun provides for the insertion of additional condiments that are normally enjoyed with hot dogs such as ketchup, mustard, relish or sauerkraut. The instant invention has been shown and described in what it considers to be the most practical and preferred embodiments. It is recognized, however, that departures may be made there from within the scope of the invention and that obvious modifications will occur to a person skilled in the art.

1. A meat product for used in conjunction with a bun for the consumption of elongated cylindrical meat products comprising:
a. a dual elongated cylindrical meat product, said cylindrical meat product appears as two merged hot dog shaped products, where the meat product is served within the bun where said bun includes
i. a first half;
ii. a first well within the interior of the first half, where the first well provides a means for the placement of a first portion of the meat product;
iii. a second half, where the second half adjoins the first half along one side the second half; and
iv. a second well within the interior of the second half, where the second well provides a means for the placement of a second portion of the meat product.

2. The meat product according to claim 1, where the bun further includes an open position for the insertion of the meat product into each well of the bun, and a closed position for consumption of the meat product within the wells.

3. The meat product according to claim 1, where the bun further includes a seam that provides a means for adjoining the first half with the second half.

4. The meat product according to claim 1, where the bun completely encloses the meat product when the bun is in the closed position.

5. The meat product according to claim 1, where the meat product is a hot dog.
